(19) United States
(12) Patent Application Publication
(10) Pub. No.: US 2010/0225580 A1
(43) Pub. Date: Sep. 9, 2010

(54) System and method of remote operation using visual code

(75) Inventors: Hyung Min Yoon, Seoul (KR); Chang Kyu Choi, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon (KR)

(21) Appl. No.: 12/461,078

(22) Filed: Jul. 30, 2009

(30) Foreign Application Priority Data
Mar. 6, 2009 (KR) 10-2009-0019124

(51) Int. Cl. G06F 3/033

(52) U.S. Cl. 345/157

(57) ABSTRACT

A remote operation method using a visual code, and an apparatus executing the method. A mobile device encodes unique data into the visual code, and displays the visual code, and a display apparatus recognizes the displayed visual code, and performs a wireless connection with the mobile device. The mobile device remotely operates a pointer of the display apparatus mapped with the visual code when the wireless connection with the display apparatus is performed. In the display apparatus without a separate operation means, a remote operation is performed using the visual code of the mobile device.

### CROSS-REFERENCE TO RELATED APPLICATIONS

This application claims the benefit of Korean Patent Application No. 10-2009-0019124, filed on Mar. 6, 2009, in the Korean Intellectual Property Office, the disclosure of which is incorporated herein by reference.

### BACKGROUND

1. Field

Example embodiments of the present disclosure may relate to a remote operation method between devices, and more particularly, to a remote operation method using a visual code and a system executing the method.

2. Description of the Related Art

With the development of the media industry, the providing of contents using a display apparatus has significantly increased. Numerous content providers may provide contents using display apparatuses mounted in public places such as a wall display, digital signage, etc. as well as existing display apparatuses such as a television, a monitor, etc. As a result, businesses which provide contents through a display apparatus have been gradually expanding.

However, in general, the display apparatuses mounted in the public places may not provide a separate operation means. As an example, a complex process including several operations may be needed to enable a user to download a free coupon provided through the wall display.

Accordingly, there arises a need for a convenient operating means of remotely operating a pointer displayed in the display apparatus without a separate operation means, thereby executing contents displayed in the display apparatus.

### SUMMARY

According to example embodiments, a display apparatus may be provided. The display apparatus may include a code decoding unit to decode a visual code, received from an image sensor, displayed on a mobile device, a connection performing unit to perform a wireless connection with the mobile device using a wireless connection address extracted from the visual code, and a pointer displaying unit to display a pointer in accordance with movement of the mobile device by tracking the movement of the mobile device.

According to other example embodiments, a mobile device may be provided. The mobile device may include an input unit to receive an input for displaying a visual code, an encoding unit to read stored unique data and to encode the read data into a visual code when receiving the input, and a visual code displaying unit to convert the visual code into an image, and to display the image so that an image sensor of a display apparatus captures the image and recognizes the visual code.

According to still other example embodiments, a remote operation method may be provided. The remote operation method may include decoding a visual code, received from an image sensor, displayed on a mobile device, operating a wireless connection with the mobile device using a wireless connection address extracted from the visual code, and displaying a pointer in accordance with movement of the mobile device by tracking the movement of the mobile device.

According to further example embodiments, a remote operation method may be provided. The remote operation method may include receiving an input for displaying a visual code, reading stored unique data, and encoding the read data into the visual code upon receiving the input, and converting the visual code into an image, and displaying the image so that an image sensor of a display apparatus captures the image and recognizes the visual code.

Additional aspects and/or advantages will be set forth in part in the description which follows and, in part, will be apparent from the description, or may be learned by practice of the example embodiments.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a process in which a mobile device according to an example embodiment remotely operates a pointer displayed in a display apparatus;

FIG. 2 illustrates a block diagram of an overall configuration of a display apparatus according to an example embodiment;

FIG. 3 illustrates a block diagram of a configuration of a pointer displaying unit, for example, the configuration of the pointer displaying unit of FIG. 2, in detail;

FIG. 4 illustrates a block diagram of an overall configuration of a mobile device according to an example embodiment;

FIG. 5 illustrates an example of a movement range in which a mobile device according to an example embodiment is moved;

FIG. 6 illustrates a movement range in which a pointer displayed in a display apparatus is moved based on a movement range of a mobile device according to an example embodiment;

FIG. 7 illustrates a flowchart of an operation process of a display apparatus being remotely operated by a mobile device according to an example embodiment; and

FIG. 8 illustrates a flowchart of an operation process of a mobile device for remotely operating a display apparatus according to an example embodiment.

### DETAILED DESCRIPTION

Reference will now be made in detail to example embodiments, examples of which are illustrated in the accompanying drawings, wherein like reference numerals refer to like elements throughout. Example embodiments are described below to explain the present disclosure by referring to the figures.

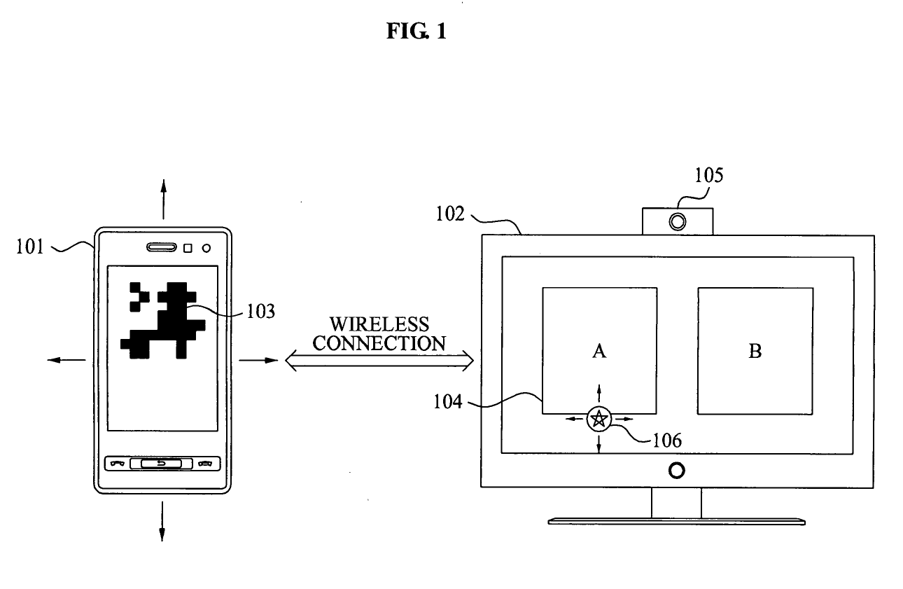

FIG. 1 illustrates a process in which a mobile device 101 according to an example embodiment remotely operates a pointer displayed in a display apparatus 102.

Referring to FIG. 1, a wireless connection is performed between the mobile device 101 and the display apparatus 102. Here, the mobile device 101 may display a visual code 103, and may include a terminal performing a wireless connection. As an example, the mobile device 101 may be a cellular phone, an MPEG layer 3 (MP3) player, a portable multimedia player (PMP), a personal digital assistant (PDA), etc., however, the present example embodiment may not be limited thereto. The display apparatus 102 may include an image sensor 105 for recognizing the visual code 103 displayed in the mobile device 101 mounted therein. The image sensor 105 may be internally or externally mounted in the display apparatus 102.

When a specific key for displaying the visual code of the mobile device 101 is pressed by a user, the mobile device 101 may read unique data and convert the read unique data into the visual code 103 of an image type. The visual code 103 converted into the image type may be displayed on the mobile device 101.

The visual code 103 may denote an identification code including unique data of the mobile device 101. Specifically, the visual code 103 may be distinctively determined for each mobile device 101. As an example, the visual code 103 may have a guide bar exhibiting a direction, and a distortion correction feature.

The image sensor 105 mounted in the display apparatus 102 may capture the visual code 103 displayed in the mobile device 101 included in a specific range, and the display apparatus 102 may perform a wireless connection with the mobile device 101 through a wireless connection address extracted from the visual code 103. As an example, the wireless connection may be a short range communication method (Bluetooth, Personal Area Network (PAN), IP, etc.).

The mobile device 101 may be moved to a desired direction of the user, and a movement of the mobile device 101 may be mapped to a pointer 106 displayed on the display apparatus 102. Specifically, the pointer 106 displayed on the display apparatus 102 may be remotely operated based on the movement of the mobile device 101. As an example, the mobile device 101 may be used for operations such as pointing rotating, tilting, performing a movement, pausing, forwarding a keystroke, etc. using the pointer 106 displayed on the display apparatus 102. As an example, when a user presses a key of the mobile device 101, content processing operations such as being clicked on, downloading, enlarging, replaying, etc. performed with respect to contents A 104 on which the pointer 106 is located may be transmitted to the display apparatus 102.

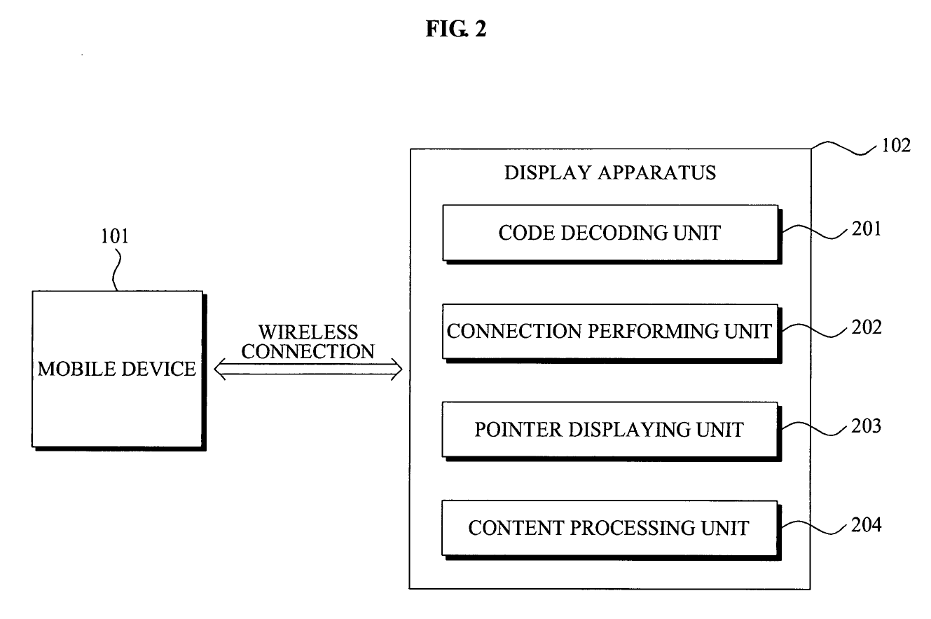

FIG. 2 illustrates a block diagram of an overall configuration of a display apparatus according to an example embodiment.

Referring to FIG. 2, the display apparatus 102 may include a code decoding unit 201, a connection performing unit 202, a pointer displaying unit 203, and a content processing unit 204.

The code decoding unit 201 may decode a visual code, received from an image sensor, displayed on the mobile device 101. In this instance, the visual code may be a code of an image type in which unique data of the mobile device is encoded. As an example, the visual code may be a code in which a wireless connection address, a user operation plane, and a user identification (ID) are encoded.

As an example, when the mobile device 1 01 exists within a range in which the display apparatus 102 recognizes an existence of the mobile device 101, the image sensor may capture the visual code displayed on the mobile device 101, and transmit the captured visual code to the code decoding unit 201. For another example, the image sensor may periodically capture an image located in a front surface of the display apparatus 102 to verify whether an image of the visual code of the mobile device 101 exists. Also, when the captured image is the image of the visual code, the image sensor may transmit the visual code to the code decoding unit 201.

The code decoding unit 201 may decode the visual code to verify whether the visual code is a code for operating the pointer of the display apparatus 102. When the visual code is verified as the code for operating the pointer, the code decoding unit 201 may extract a wireless connection address of the mobile device, a user operation plane, and a user ID, each being encoded in the visual code.

The connection performing unit 202 may perform a wireless connection with the mobile device 101 using the wireless connection address extracted from the visual code. As an example, the wireless connection address may be a Bluetooth address. According to an example embodiment, when the visual code is inputted to be displayed, the visual code may be displayed on the mobile device 101 even without performing an additional process, and the display apparatus 102 may sense the visual code to enable the wireless connection with the mobile device 101 to be performed.

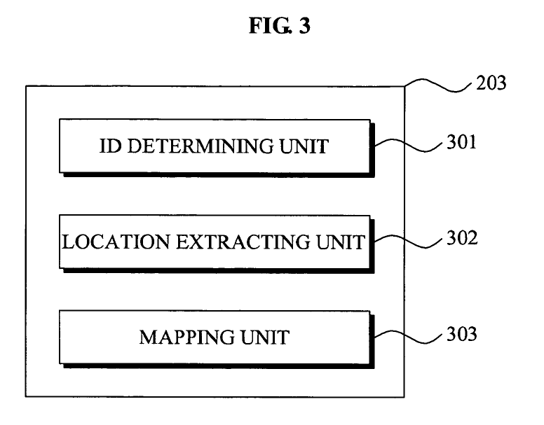

The pointer displaying unit 203 may display a pointer in accordance with a movement of the mobile device 101 by tracking the movement of the mobile device 101. The pointer displaying unit 203 may reflect the movement of the mobile device 101 in the pointer displayed on the display apparatus 102. The pointer displaying unit 203 will be described in detail with reference to FIG. 3.

Thus, according to an example embodiment, the display apparatus 102 may operate the pointer displayed on the display apparatus 102 using the mobile device 101 displaying the visual code even in a case where a separate operation means is not provided.

The content processing unit 204 may process contents corresponding to a location of the pointer when receiving a content processing input from the mobile device 102. As an example, when a user transmits a content download input to the display apparatus 102 using the mobile device 101 in a case where a content A (FIG. 1, 104) is displayed on the display apparatus 102 and a pointer mapped to the mobile device 101 is located in the content A (FIG. 1, 104), the content processing unit 204 may upload the content A (FIG. 1, 104) in the mobile device 101. The content processing input may include various operations for contents such as content replaying, downloading, selecting, zooming, sliding, and the like. However, the above described operations for contents are merely examples, and the present example embodiment may not be limited thereto.

FIG. 3 illustrates a block diagram of a configuration of a pointer displaying unit of a display apparatus according to an example embodiment, in detail.

Referring to FIGS. 2 and 3, the pointer displaying unit 203 may include an ID determining unit 301, a location extracting unit 302, and a mapping unit 303.

The ID determining unit 301 may determine whether a user ID extracted from the visual code of the mobile device 101 is stored. As an example, at least one mobile device 101 may operate contents displayed on the display apparatus 102 using a visual code. In this instance, the ID determining unit 301 may determine whether the user ID is stored, so that a plurality of mobile devices 101 are identified using the user ID. Here, the mobile device 101 having a user ID stored may denote a terminal having a record in which the mobile device 101 has been connected with the display apparatus 102.

The location extracting unit 302 may extract an absolute location of the mobile device 101 using the visual code when the user ID is stored. As an example, the location extracting unit 302 may calculate a distance in which the mobile device 101 is moved by a user based on a size or shape of the visual code, and extract the absolute location of the mobile device 101. Specifically, the location extracting unit 302 may determine which point (x, y) of a specific space the mobile device 101 is located in, based on a distance in which a user's hand with the mobile device 101 is movable. As an example, the distance by which the mobile device 101 is movable may be determined using a user operation plane extracted by decoding the visual code.

The mapping unit 303 may map a movement range of the mobile device 101 to a movement range of a pointer using a virtual operation plane of the mobile device 101. As an example, the mapping unit 303 may set the virtual operation plane based on the distance in which the mobile device 101 is movable, with respect to a point where the visual code displayed on the mobile device 101 is recognized. In this instance, the virtual operation plane may correspond to an overall size of the display apparatus 102. The mapping unit 303 may determine a ratio of the movement range of the pointer based on the movement range of the mobile device 101 in the virtual operation plane. Consequently, the pointer displaying unit 203 may apply the ratio of the movement range of the pointer to the movement range of the mobile device 101 to thereby calculate a location of the pointer displayed on the display apparatus 102. As an example, when the mobile device 101 is moved to the right by 3 cm and the determined ratio is 3.5, the pointer displayed on the display apparatus 102 may be located in a point where the pointer is moved to the right by 10.5 cm.

For another example, the display apparatus 102 may set a maximum virtual operation plane, that is, a range where the display apparatus 102 recognizes an existence of the mobile device 101 using the image sensor In this instance, the maximum virtual operation plane may be determined by a resolution of the image sensor, a location of the image sensor mounted in the display apparatus, and a direction to which the image sensor is oriented. The virtual operation plane may denote a range set with respect to a point where the mobile device 101 is recognized in the maximum virtual operation plane.

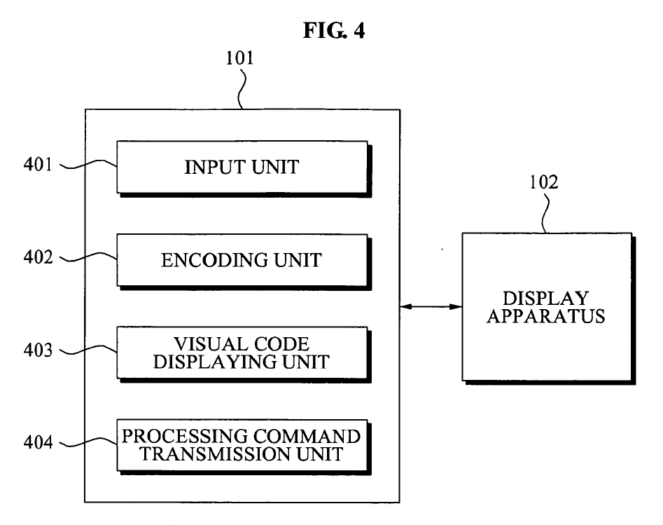

FIG. 4 illustrates a block diagram of an overall configuration of a mobile device according to an example embodiment.

Referring to FIG. 4, the mobile device 101 may include an input unit 401, an encoding unit 402, a visual code displaying unit 403, and a processing command transmission unit 404.

The input unit 401 may receive an input for displaying a visual code. As an example, the input unit 401 may receive, from a user, an input for displaying the visual code on a window of the mobile device 101.

When receiving the input, the encoding unit 402 may read stored unique data, and encode the read unique data into the visual code. As an example, the encoding unit 402 may read a wireless connection address of the mobile device 101, a user operation plane, and a user ID, and encode the read wireless connection address, user operation plane, and user ID into the visual code.

The visual code displaying unit 403 may convert the encoded visual code into an image, and display the image so that the image sensor of the display apparatus 102 captures and recognizes the image. The visual code may denote an identification code including the unique data of the mobile device 101. Specifically, the visual code may be distinctively determined for each mobile device 101. As an example, the visual code may have a guide bar exhibiting a direction, and a distortion correction feature.

As an example, when the mobile device 101 in which the visual code is displayed approaches the display apparatus 102 including the image sensor mounted therein, the display apparatus 102 may recognize the visual code using the image sensor. Then, the display apparatus 102 may perform a wireless connection with the mobile device 101 using a wireless connection address.

The processing command transmission unit 404 may transmit a processing command of contents corresponding to a pointer mapped with the visual code in the display apparatus 102, when the wireless connection with the display apparatus 102 is performed using the visual code converted into the image. Specifically, a movement of the pointer of the display apparatus 102 may correspond to a movement of the mobile device 101. The mobile device 101 may transmit a content processing command such as loading, deleting, enlarging, reducing, replaying, etc. Thereafter, the display apparatus 102 may process, based on the content processing command, contents pointed to by the pointer.

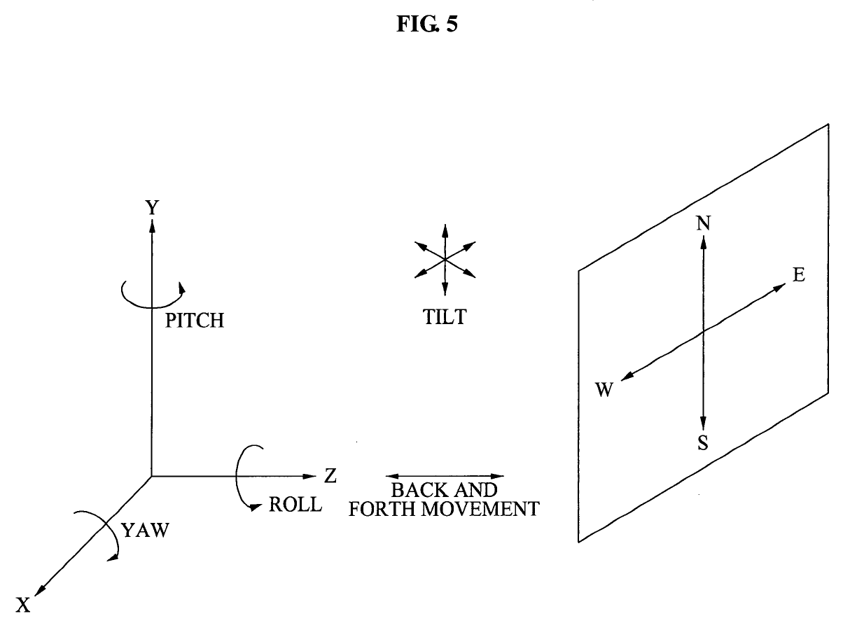

FIG. 5 illustrates an example of a movement range in which a mobile device according to an example embodiment is moved.

When an existing 3D input device (for example, a mouse, etc.) is used as an input device on a space, operations in six directions (six degrees of freedom (6 DOF)) including rotations in respective directions of Yaw, Pitch, and Roll, and movements in directions of X, Y, and Z may be supported, as illustrated in FIG. 5.

In the mobile device 101 according to an example embodiment, the pointer displayed on the display apparatus 102 may be operated using a movement in four directions of north, south, east, and west, back and forth movement, and a tilt in each direction.

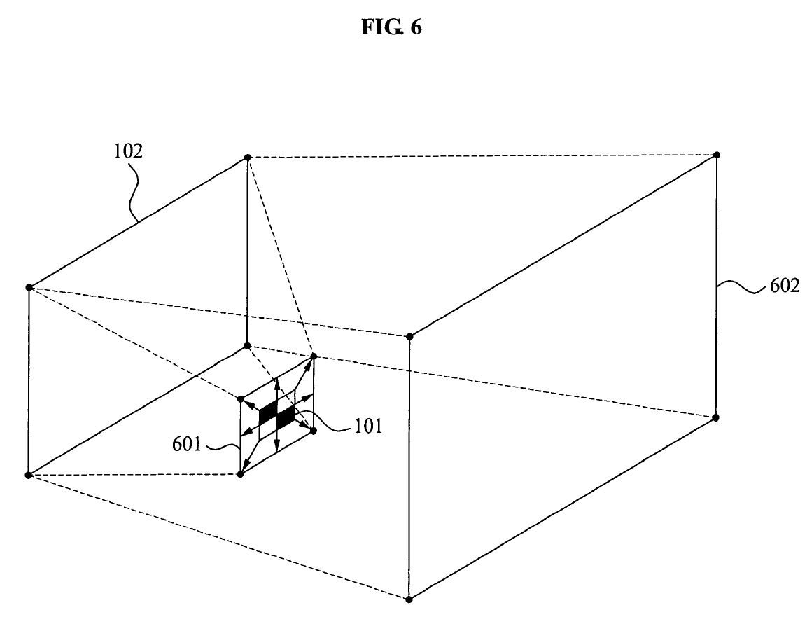

FIG. 6 illustrates a movement range in which a pointer displayed in a display apparatus is moved based on a movement range of a mobile device according to an example embodiment.

Referring to FIG. 6, the mobile device 101 where the visual code is displayed is illustrated. A maximum virtual operation plane 602 determined by the image sensor mounted in the display apparatus 102 is illustrated in FIG. 6. When the mobile device 101 where the visual code is displayed is included in the maximum virtual operation plane 602, the display apparatus 102 may recognize the mobile device 101 using the image sensor.

When the mobile device 101 is recognized, the display apparatus 102 may calculate a distance in which the mobile device 101 is movable. Then, the display apparatus 102 may set the virtual operation plane 601 based on the calculated distance with respect to the point where the mobile device 101 is recognized. In this instance, the virtual operation plane 601 may correspond to an overall size of the display apparatus 102. Also, the display apparatus 102 may determine a ratio of the movement range of the pointer in accordance with the movement range of the mobile device 101 in the virtual operation plane 601. As an example, the ratio of the movement range may be determined according to a geometrical ratio.

When the mobile device 101 is moved within the virtual operation plane 601, the display apparatus 102 may apply the determined ratio to the movement range of the mobile device 101 to thereby calculate the movement range of the pointer displayed on the display apparatus 102.

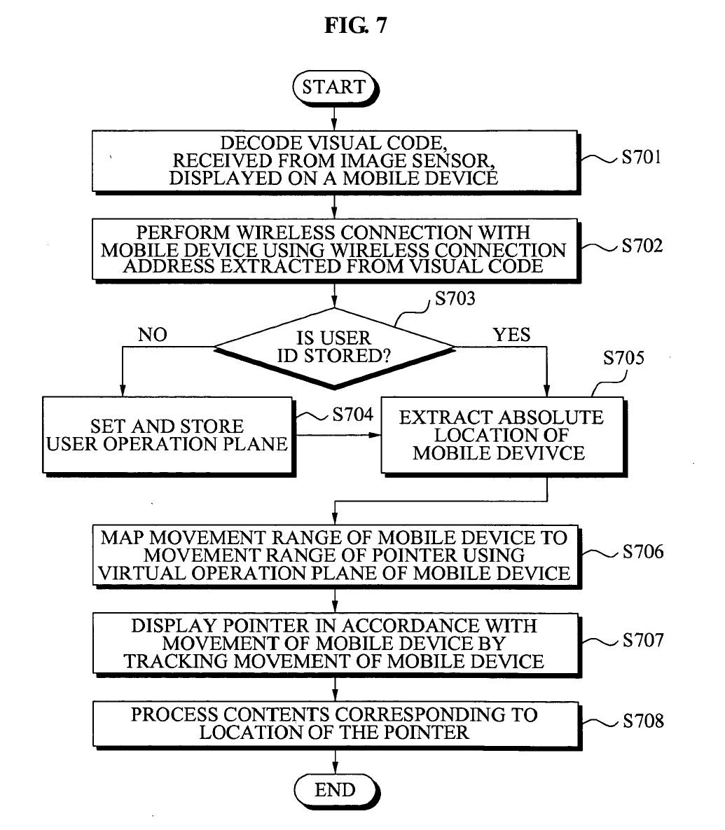

FIG. 7 illustrates a flowchart of an operation process of a display apparatus being remotely operated by a mobile device according to an example embodiment.

Referring to FIGS. 1 and 7, in operation S701, the display apparatus 102 may decode a visual code, received from an image sensor, displayed on the mobile device 101. The display apparatus 102 may extract a wireless connection address of the mobile device 101, a user operation plane, and a user ID through decoding of the visual code.

In operation S702, the display apparatus 102 may perform a wireless connection with the mobile device 101 using the wireless connection address extracted from the visual code. In this instance, a method of performing the wireless connection may not be limited.

In operation S703, the display apparatus 102 may determine whether the user ID extracted from the visual code is already stored. In operation S704, when the user ID is not stored, the display apparatus 102 may recognize the mobile device 101 as a new mobile device to thereby set the user operation plane of the mobile device 101 and store the set user operation plane, and then the display apparatus 102 may advance to operation S705. In operation S704, when the user ID is stored, the display apparatus may advance to operation S705. In operation S705, when the user ID is stored, the display apparatus 102 may extract an absolute location of the mobile device 101. In this instance, the display apparatus 102 may extract the absolute location of the mobile device 101 using the visual code. As an example, the display apparatus 102 may calculate a distance in which the mobile device is movable by a user based on a size or shape of the visual code, and extract the absolute location of the mobile device 101.

In operation S706, the display apparatus 102 may map a movement range of the mobile device 101 to a movement range of the pointer using a virtual operation plane of the mobile device 101. As an example, the display apparatus 102 may set the virtual operation plane based on the calculated distance with respect to a point where the visual code displayed on the mobile device 101 is recognized. Then, the display apparatus 102 may determine a ratio of the movement range of the pointer based on the movement range of the mobile device in the virtual operation plane.

In operation S707, the display apparatus 102 may display a pointer in accordance with movement of the mobile device 101 by tracking the movement of the mobile device 101. In this manner, the mobile device 101 controls the pointer of the display apparatus 102.

In operation S708, the display apparatus 102 may process contents corresponding to a location of the pointer when receiving a content processing input from the mobile device 101.

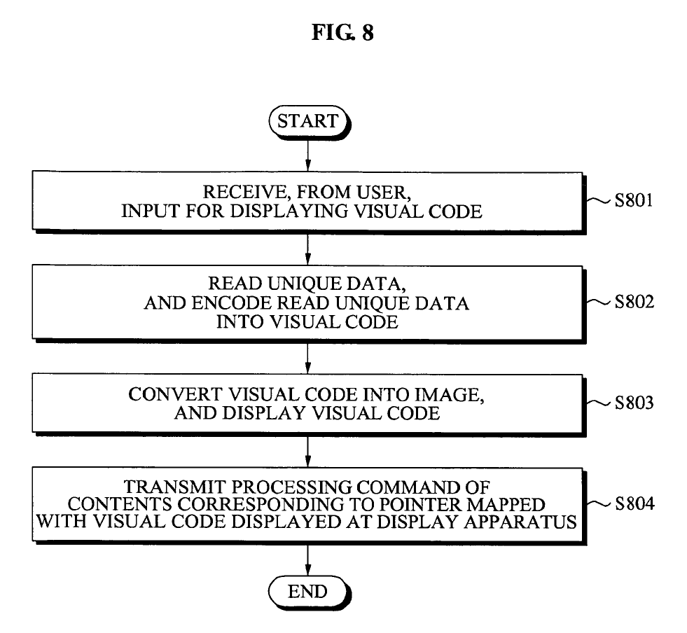

FIG. 8 illustrates a flowchart of an operation process of a mobile device for remotely operating a display apparatus according to an example embodiment.

In operation S801, the mobile device 101 may receive, from a user, an input for displaying the visual code.

In operation S802, the mobile device 101 may read stored unique data to encode the read unique data into the visual code when receiving the input from the user.

In operation S803, the mobile device 101 may convert the encoded visual code into an image, and display the encoded visual code so that an image sensor of the display apparatus 102 captures and recognizes the encoded visual code.

In operation S804, the mobile device 101 may transmit a processing command of contents corresponding to a pointer mapped with the visual code displayed on the display apparatus 102.

Non-described features of FIGS. 7 and 8 will be understood with reference to descriptions of FIGS. 1 to 6.

In addition to the above described embodiments, embodiments can also be implemented through computer readable code/instructions in/on a medium, e.g., a computer readable medium, to control at least one processing device to implement any above described embodiment. The medium can correspond to any medium/media permitting the storing and/or transmission of the computer readable code. Examples of code/instructions may include machine code, produced by a compiler, and files containing higher level code that may be executed by the computer using an interpreter.

The computer readable code can be recorded on a medium in a variety of ways, with examples of recording media including magnetic storage media (e.g., ROM, floppy disks, hard disks, etc.) and optical recording media (e.g., CD-ROMs, or DVDs). The computer readable code may also be transferred through transmission media as well as elements of the Internet, for example. Thus, the medium may be such a defined and measurable structure carrying or controlling a signal or information, such as a device carrying a bitstream, for example, according to one or more embodiments. The media may also be a distributed network, so that the computer readable code is stored/transferred and executed in a distributed fashion. Still further, as only an example, the processing device could include a processor or a computer processor, and processing elements may be distributed and/or included in a single device.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A display apparatus, comprising:
a code decoding unit to decode a visual code, received from an image sensor, displayed on a mobile device;
a connection performing unit to operate a wireless connection with the mobile device using a wireless connection address extracted from the visual code; and
a pointer displaying unit to display a pointer in accordance with movement of the mobile device by tracking the movement of the mobile device.

2. The display apparatus of claim 1, wherein the code decoding unit decodes the visual code in which the wireless connection address of the mobile device, a user operation plane, and a user identification (ID) are encoded.

3. The display apparatus of claim 1, wherein the pointer displaying unit includes:
an ID determining unit to determine whether a user ID extracted from the visual code of the mobile device is stored;
a location extracting unit to extract an absolute location of the mobile device using the visual code when the user ID is stored; and
a mapping unit to map a movement range of the mobile device to a movement range of the pointer using a virtual operation plane of the mobile device.

4. The display apparatus of claim 3, wherein the location extracting unit calculates a distance in which the mobile device is moved by a user based on a size or a shape of the visual code and extracts the absolute location of the mobile device.

5. The display apparatus of claim 4, wherein
the mapping unit sets the virtual operation plane based on the distance with respect to a point where the visual code displayed on the mobile device is recognized, and determines a ratio of the movement range of the pointer based on the movement range of the mobile device in the virtual operation plane, and wherein
the virtual operation plane corresponds to an overall size of the display apparatus.

6. The display apparatus of claim 1, further comprising:
a content processing unit to process contents corresponding to a location of the pointer when receiving a content process input from the mobile device.

7. A mobile device comprising:
an input unit to receive an input for displaying a visual code;
an encoding unit to read stored unique data and to encode the read data into a visual code when receiving the input; and
a visual code displaying unit to convert the visual code into an image, and to display the image so that an image sensor of a display apparatus captures the image and recognizes the visual code.

8. The mobile device of claim 7, further comprising:
a processing command transmission unit to transmit a processing command of contents corresponding to a pointer mapped with the visual code displayed on the display apparatus, upon a wireless connection with the display apparatus having been performed using the visual code converted into the image.

9. The mobile device of claim 7, wherein the display apparatus displays a pointer in accordance with movement of the mobile device by tracking the movement of the mobile device.

10. The mobile device of claim 9, wherein the display apparatus detects a location of the mobile device using the visual code of the mobile device, and maps a movement range of the mobile device to a movement range of the pointer of the display apparatus.

11. A remote operation method, comprising:
decoding a visual code, received from an image sensor, displayed on a mobile device;
operating a wireless connection with the mobile device using a wireless connection address extracted from the visual code; and
displaying a pointer in accordance with movement of the mobile device by tracking the movement of the mobile device.

12. The remote operation method of claim 11, wherein the decoding decodes the visual code in which the wireless connection address of the mobile device, a user operation plane, and a user identification (ID) are encoded.

13. The remote operation method of claim 11, wherein the displaying includes:
determining whether a user ID extracted from the visual code of the mobile device is stored;
extracting an absolute location of the mobile device using the visual code upon determining that the user ID is stored; and
mapping a movement range of the mobile device to a movement range of the pointer using a virtual operation plane of the mobile device.

14. The remote operation method of claim 13, wherein the extracting calculates a distance in which the mobile device is moved by a user based on a size or a shape of the visual code and extracts the absolute location of the mobile device.

15. The remote operation method of claim 14, wherein the mapping includes:
setting the virtual operation plane based on the distance with respect to a point where the visual code displayed on the mobile device is recognized; and
determining a ratio of the movement range of the pointer based on the movement range of the mobile device in the virtual operation plane,
wherein the virtual operation plane corresponds to an overall size of a display apparatus.

16. The remote operation method of claim 11, further comprising:
processing contents corresponding to a location of the pointer when receiving a content processing input from the mobile device.

17. A remote operation method, comprising:
receiving an input for displaying a visual code;
reading stored unique data, and encoding the read data into the visual code upon receiving the input; and
converting the visual code into an image, and displaying the image so that an image sensor of a display apparatus captures the image and recognizes the visual code.

18. The remote operation method of claim 17, further comprising:
transmitting a processing command of contents corresponding to a pointer mapped with the visual code displayed on the display apparatus, upon a wireless connection with the display apparatus having been performed using the visual code converted into the image.

19. The remote operation method of claim 17, wherein the display apparatus displays a pointer in accordance with movement of a mobile device by tracking the movement of the mobile device.

20. The remote operation method of claim 19, wherein the display apparatus detects a location of the mobile device using the visual code of the mobile device, and maps a movement range of the mobile device to a movement range of the pointer of the display apparatus.
